(19) United States
(12) Patent Application Publication
(10) Pub. No.: US 2026/0215353 A1
(43) Pub. Date: Jul. 30, 2026

(54) Tractor Implement Control Without Positional Feedback

(71) Applicant: Autonomous Solutions, Inc., Mendon, UT (US)

(72) Inventors: Robert Ashby, Mendon, UT (US); Bret Turpin, Mendon, UT (US); Mitch Torrie, Mendon, UT (US)

(73) Assignee: Autonomous Solutions, Inc., Mendon, UT (US)

(21) Appl. No.: 19/458,174

(22) Filed: Jan. 23, 2026

Related U.S. Application Data
(60) Provisional application No. 63/749,257, filed on Jan. 24, 2025.

(51) Int. Cl. A01B 69/00; A01B 63/32; A01B 69/04; A01B 71/02

(52) U.S. Cl. CPC A01B 69/004; A01B 63/32; A01B 69/008; A01B 71/02

(57) ABSTRACT

Disclosed are autonomous work vehicles and adjustable implement systems for automatically and/or autonomously adjusting the position of an implement. The implement may be adjusted by receiving implement data from a sensor array, determining a position of the implement based on implement data, and instructing the implement control system to adjust the position of the implement to a desired position. The sensor array may include a tractor engine torque sensor, a wheel speed sensor, and/or a LiDAR sensor. The implement may be connected to a hydraulic cylinder. The implement data may indicate parameters of the implement, including timing data and/or flow data indicating the flow rate of hydraulic fluid in or out of the hydraulic cylinder. The extension of hydraulic cylinder may be determined based on the timing data and/or the flow data and position of the implement may then be determined based on the extension of the hydraulic cylinder.

### BACKGROUND

Vehicles systems including tractors and implements often require some positional feedback of the implement. Typically, the position of an implement is monitored by sensors on an implement.

### SUMMARY

Disclosed are autonomous work vehicles, adjustable implement systems, and methods for automatically and/or autonomously adjusting the position of an implement which may be attached to a (e.g., autonomous) work vehicle. The autonomous work vehicle may comprise a steering control system for autonomously controlling a driving direction of the autonomous work vehicle and a speed control system for autonomously controlling a speed of the autonomous work vehicle. The autonomous work vehicle may comprise an implement connection between the autonomous work vehicle and an implement, wherein the implement may be configured to interface with objects of an operating environment. The autonomous work vehicle may comprise an implement control system for autonomously controlling a position of the implement and a sensor array comprising one or more sensors configured to measure one or more parameters of the implement.

The autonomous work vehicle may comprise one or more processors communicatively coupled with the sensor array, the steering control system, and the speed control system, and one or more computer-readable media having stored thereon instructions for executing a method for adjusting the position of the implement. The autonomous work vehicle may further comprise a hydraulic cylinder connected to the implement for adjusting the position of the implement.

The method for adjusting the position of the implement may comprise receiving implement data from the sensor array, wherein the implement data indicates one or more parameters of the implement, determining a position of the implement based on the implement data, and instructing the implement control system to autonomously adjust the position of the implement to a desired position. The implement data may comprise timing data from a clock, and the method may further include determining an extension of the hydraulic cylinder based on the timing data and determining the position of the implement based on the extension of the hydraulic cylinder. The implement data may further comprise flow data relating to a controlled flow rate of hydraulic fluid into or out of the hydraulic cylinder, and the method may further comprise determining an extension of the hydraulic cylinder based on the flow data and the timing data.

Instructing the implement control system to automatically adjust the position of the implement to a desired position may comprise determining a required change in extension of the hydraulic cylinder for the implement to reach the desired position, determining a set time required for hydraulic flow into or out of the hydraulic cylinder at a predetermined flow rate to meet the required change in extension of the hydraulic cylinder, and controlling a pump to induce a flow of hydraulic fluid at the predetermined flow rate into or out of the hydraulic cylinder for the set time.

In some embodiments, the implement may comprises a disc harrow configured to interface with a ground surface of the operating environment. The implement may be attached to a hydraulic cylinder for actuating a height of discs of the implement relative to a ground surface of the operating environment. Determining a position of the implement based on the implement data may comprise determining a height of the discs based on a timing data and the flow data, and instructing the implement control system to autonomously adjust the position of the implement to a desired position may comprise instructing the implement control system to adjust the flow rate of hydraulic fluid into or out of the hydraulic cylinder.

The implement may be a digger bucket, a dump truck bed, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a tiller, a rotavator, a ditcher, a dozer blade, a backhoe, an excavator, a spreader, a fertilizer, a seeder, a disc plow, or a plow. The sensor array may comprise tractor engine torque sensor, a wheel speed sensor, and/or a visual sensor, such as a LiDAR sensor. For example, the position of the implement may be determined based on detection of tire slip as indicated by the wheel speed sensor. The desired position of the implement may be based on the position of the autonomous work vehicle along a selected path. The desired position of the implement may be based on manual input received from an operator.

Also disclosed are adjustable implement systems (e.g., configured to attach to an autonomous work vehicle) for automatically or autonomously adjusting the position of an implement. The adjustable implement system may comprise an implement configured to interface with objects within an operating environment, a vehicle connection point for attaching the implement to a work vehicle, and a communications connection for receiving implement data from a sensor array. The sensor array may comprises one or more sensors configured to measure one or more parameters of the implement. The adjustable implement system may comprise an implement control system for automatically controlling a position of the implement, one or more computer-readable media having stored thereon instructions for executing a method to adjust the position of the implement. The method may comprise receiving implement data from the sensor array, wherein the implement data indicate one or more parameters of the implement, determining a position of the implement based on the implement data, and instructing the implement control system to automatically adjust the position of the implement to a desired position.

The adjustable implement system may further comprise a hydraulic cylinder attached to the implement. The sensor array may comprise a flow sensor on the hydraulic cylinder, and the implement data may comprise flow data from the flow sensor relating to a flow rate of hydraulic fluid into or out of the hydraulic cylinder. Th implement data may comprise timing data from a clock. The implement control system may be configured to determine an extension of the hydraulic cylinder based on the flow data and timing data and can determine the position of the implement based on the extension of the hydraulic cylinder. The adjustable implement system may further comprise a communication link with a vehicle control unit of an autonomous work vehicle and the implement control system may receive implement data from the vehicle control unit.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 schematically shows an isometric view of an example vehicle system including a tractor with an implement.

FIG. 2 illustrates a block diagram of an example autonomous work vehicle communication system of the present disclosure.

FIG. 3 is a side view of an autonomous yard truck according to some embodiments.

FIG. 4 is a perspective view of an autonomous mower according to some embodiments.

FIG. 5 is a side view of an autonomous tractor according to some embodiments.

FIG. 6 shows an illustrative computational system for performing functionality to facilitate implementation of embodiments described in this document.

FIG. 7 is a flow chart of an example process for controlling an implement to move to a desired position.

FIG. 8 is a flow chart of an example process for determining a current position of an implement.

### DETAILED DESCRIPTION

Implements may be attached to work vehicles to perform particular tasks. For example, farming implements may be attached to tractors to perform agricultural tasks, such as preparing soil, planting, fertilizing, applying pesticide, and harvesting tasks. Construction vehicles may rely on attached implements for preparing worksites, moving materials, and otherwise facilitating the building of structures.

The development of autonomous work vehicles may beneficially reduce the manual labor of human operators required to drive work vehicles and perform associated tasks. The need for autonomously-directed implements has grown with the development of autonomously-driving work vehicles. What are needed are autonomous work vehicles and adjustable implement systems that autonomously control implements to perform tasks.

Disclosed are autonomous work vehicles, adjustable implement systems, and methods for controlling implements of these vehicles and systems. Automatic and/or autonomous control of the implement may include detecting the position of an implement, determining a desired position of the implement, and instructing an implement control system to adjust the position of the implement. The position of the implement may be determined based on implement data received from a sensor array. The implement data may include timing data, flow data (e.g., of a hydraulic fluid), visual sensor (e.g., LiDAR sensor, camera sensor, radar, infrared sensor) data, or other data indicating one or more parameters of the implement. The implement may be connected to a hydraulic cylinder and the implement may be actuated by adjusting a flow rate of the fluid within the hydraulic cylinder.

While the disclosed methods may be employed to control an implement of an autonomous work vehicle, the disclosed methods may be used in other contexts. For example, an operator may drive a vehicle and operate an implement simultaneously. Frequently, driving conditions may cause the position of the implement to deviate and the operator may not be aware of the positional deviation for a period of time due to the attention needed to drive the vehicle. This may lead to reduced efficacy and/or efficiency of the performance of the task. However, the disclosed systems and methods may be employed to automatically and/or autonomously control an implement (e.g., to adjust the position of an implement) attached to a manually-driven vehicle. The disclosed controlled implement systems may beneficially optimize performance, reduce and/or prevent operational delays, and improve energy and material efficiency. This may also beneficially prevent or reduce wear on equipment of the vehicle and/or implement, for example, due to changing conditions within the operating environment and/or poor decision making of an operator.

As used herein, the term “autonomous work vehicle” may refer to a vehicle configured to perform a task within an operating environment. The autonomous work vehicle may refer to a vehicle that may be driven by an autonomous system with little or no human input. The autonomous work vehicle may refer to a driving unit (e.g., a tractor) attached to an implement, or may refer to the driving unit as distinct from the implement. While an autonomous work vehicle is described in connection to the disclosed embodiments throughout this description, manually-operated vehicles may alternatively be used. Considering this, wherever possible, one may substitute the term “autonomous work vehicle” with the term “work vehicle,” “manual vehicle,” “manned vehicle,” “manually-operated vehicle,” or other term indicating a non-autonomously-driven vehicle.

As used herein, the term “implement” may refer to a device connected (detachably or permanently) to a vehicle and which is configured to interface and/or interact with objects (beyond the vehicle to which it is connected) within the operating environment. The implement may include farming implements, construction implements, or other vehicle attachments. The implement may include a vehicle connection point for detachably and/or pivotably connecting the implement to a vehicle (e.g., an autonomous work vehicle). The implement may be configured, for example, to move objects within the operating environment, to cut or partition objects, or to bind objects together. The implement may configured to interface with a ground surface of the operating environment.

As used herein, the term “automatic” may refer to an action, process, or system that is performed or performs with reduced human intervention. Automatic systems may continue to receive a minimum of human input to complete performance. An automatic system may enable performance by the system with less human input when compared to a non-automatic or manual system.

As used herein, the term “autonomous” may refer to an action, process, or system that may perform or be performed without any human input or intervention. An “automatic system” may be “autonomous” when it relies on no human input to perform a process of the system.

Systems and/or methods are disclosed for determining a position of an implement attached to an autonomous vehicle (e.g., a tractor), and for controlling the position of the implement.

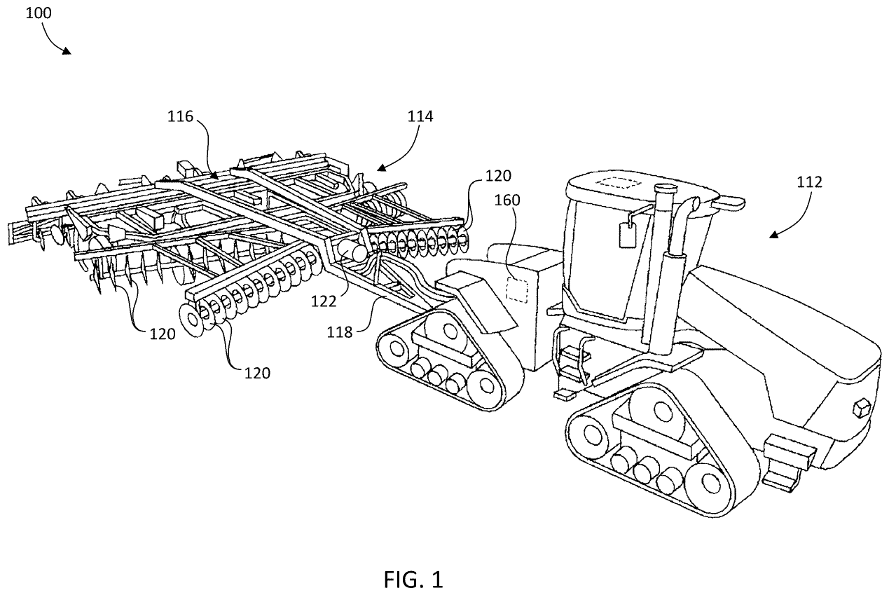

FIG. 1 is a diagram illustrating an autonomous work vehicle 100 including a tractor 112 comprising an implement 114 attached thereto. The implement 114 in this example is a disc harrow which is carried behind the tractor 112. In other examples, the implement may be a digger bucket, a dump truck bed, a plough, a harvesting implement, cultivator, plow, chisel, mower, grader, harvester, rake, rock picker, tiller, rotavator, ditcher, dozer blade, backhoe, seeder, tiller, fertilizer, spreader, excavator, disc plow, disc harrows, blade, etc. The implement 114 may, for example, comprise a frame 116 including a tow bar 118 by which the implement 114 can be towed by the tractor 112. A plurality of discs 120 may be arranged in rows on either side of the tow bar 118. The discs 120 may be mounted to the frame 116 with bearings (not shown) and may be configured to rotate, via the bearings, on an axis parallel to a respective row in which the disc 120 is arranged. The autonomous work vehicle 100 may comprise a hydraulic cylinder 122 to which the implement 114 is attached and which is configured to enable movement of the implement 114 between different positions by extending and retracting. Movement of the implement 114 to a different position may relate to different positions relative to the tractor 112, or movement to a different absolute position in space. The hydraulic cylinder 122 may be a separate component to the implement 114, or in some examples, the hydraulic cylinder 122 may be considered to be a part of the implement, such that it is configured to enable movement of another part of the implement by extending or retracting. The hydraulic cylinder 122 may have its own engine or hydraulic pump, or an engine or hydraulic pump may be run be a power take-off from the tractor 112. A sensor array 160 may be disposed on the tractor 112 and configured to sense various operational parameters of the tractor 112 and/or the implement 114.

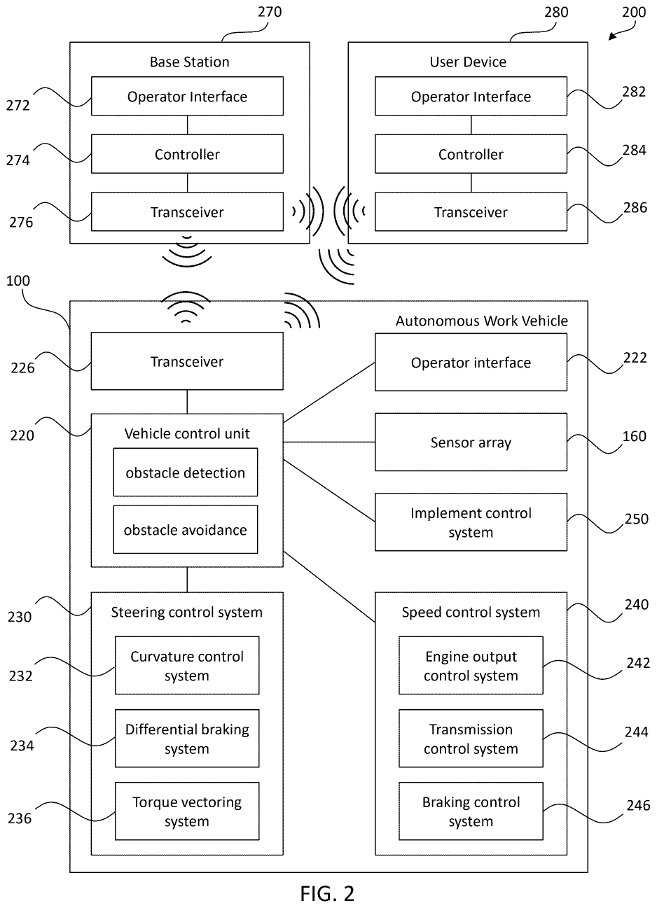

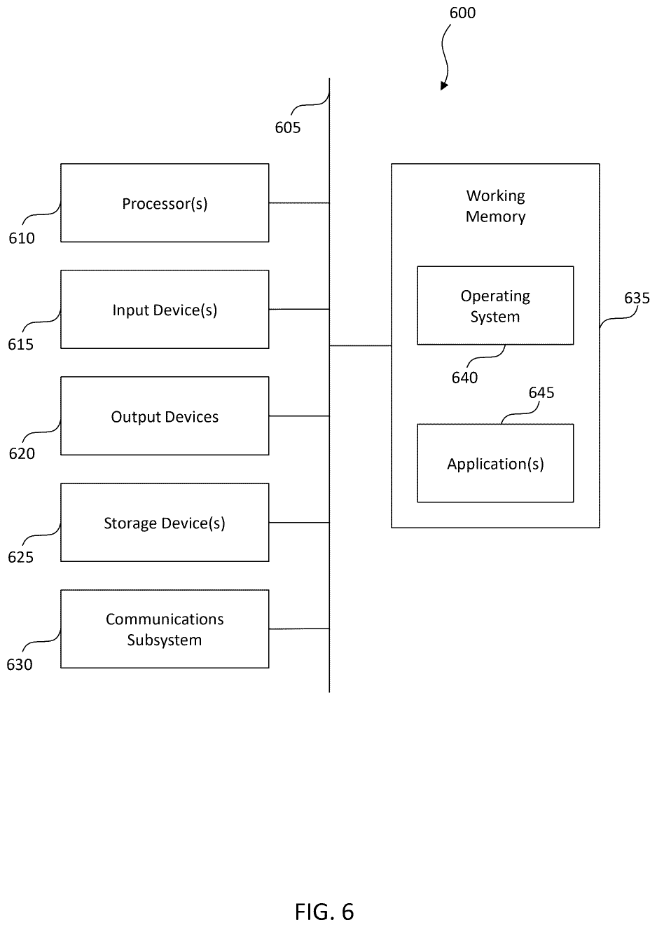

FIG. 2 is a block diagram of a communication and control system 200 that may be utilized in conjunction with the systems and methods of the disclosure. All or some of the components of control system 200 may or may not be included in an autonomous vehicle in any combination. All or some of the components of control system 200 may be included in an autonomous vehicle, an implement, a remote system in any combination. The communication and control system 200 may include a vehicle control unit 220 which may be mounted on the autonomous work vehicle 100. The autonomous work vehicle 100, for example, may include any agricultural or construction machinery including, for example, a yard truck, loader, wheel loader, track loader, dump truck, digger, backhoe, forklift, harvester, tractor, land leveler, scraper, dozer, trencher, grader, seeder, fertilizer, spreader, mower (e.g., lawn, field, or brush mower), harrow, etc., any machinery or implement discussed in this document, or other vehicle or implement. The communication and control system 200, for example, may include any or all components of computational system 600 shown in FIG. 6, described below.

For example, the autonomous work vehicle 100 may include a steering control system 230 that may control a direction of movement of the autonomous work vehicle 100. The steering control system 230, for example, may include any or all components of computational system 600 shown in FIG. 6.

The autonomous work vehicle 100, for example, may include a speed control system 240 that controls the speed, acceleration, and deceleration of the autonomous work vehicle 100. The speed control system 240, for example, may control the speed of the autonomous work vehicle 100 based on map data, control algorithms, obstacle detection, start and/or stop points, input from the base station 270 and/or operator (e.g., a remote operator), etc. The speed control system 240, for example, may include any or all components of computational system 600 shown in FIG. 6.

The autonomous work vehicle 100, for example, may include an implement control system 250 that may control operation of an implement towed by the autonomous work vehicle 100 (e.g., tractor 112), integrated within the autonomous work vehicle 100, or coupled to the autonomous work vehicle 100. The implement control system 250, for example, may include any type of implement such as, for example, a disc harrow, a bucket, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a rotavator, a ditcher, a dozer blade, a backhoe, an excavator, a disc plow, etc. The implement control system 250, for example, may include any or all components of computational system 600 shown in FIG. 6.

An implement may also be considered an attachment. An implement may be coupled with the autonomous vehicle by a user or may be integrated with the autonomous vehicle.

The vehicle control unit 220 may be communicatively coupled with the steering control system 230, the speed control system 240, and/or the implement control system 250. The vehicle control unit 220, for example, may include any or all of the components shown in FIG. 6. The vehicle control unit 220, for example, may be integrated into a single controller or may include a plurality of distinct components or controllers. The vehicle control unit 220 may also be coupled with one or more sensors from the sensor array 160 and receive sensor data from the sensor array 160.

The vehicle control unit 220, for example, may be used to control various aspects of the vehicle 100 such as, for example, sending instructions to the steering control system 230, implement control system 250, speed control system 240, etc. The vehicle control unit 220, for example, may include a vehicle artificial intelligence (VAI) that may include one or more processors that execute one or more algorithms, including processes 700 and/or 800 disclosed below.

The vehicle control unit 220, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 160 or from a base station 270 (described below).

The vehicle control unit 220, for example, may be an electronic controller with electrical circuitry configured to process data from the various components of the autonomous work vehicle 100. The vehicle control unit 220 may include a processor, such as the processor 610, and a working memory 635. The vehicle control unit 220 may also include one or more storage devices, storage media, and/or other suitable components of computational system 600. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 220, for example, may include any or all the components shown in FIG. 6.

The vehicle control unit 220, for example, may include a volatile memory, such as random access memory (RAM), and/or a nonvolatile memory, such as ROM (e.g., working memory 635, storage device 625, and/or other computer-readable media). The memory may store a variety of information and may be used for various purposes. For example, the memory may store processor-executable instructions (e.g., firmware or software) for the vehicle control unit 220 to execute, such as instructions for calculating a drivable path plan, and/or controlling the autonomous work vehicle 100 (e.g., for implementing processes 700 and/or 800 below). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 230, for example, may include a curvature rate control system 232, a differential braking system 234, a steering mechanism, and a torque vectoring system 236 that may be used to steer the autonomous work vehicle 100. The curvature rate control system 232, for example, may control a direction of an autonomous work vehicle 100 by controlling a steering control system of the autonomous work vehicle 100 with a curvature rate, such as an Ackerman style autonomous work vehicle, 210 or articulating vehicle. The curvature rate control system 232, for example, may automatically rotate one or more wheels or tracks of the autonomous work vehicle 100 via hydraulic or electric actuators to steer the autonomous work vehicle 100. By way of example, the curvature rate control system 232 may rotate front wheels/tracks, rear wheels/tracks, and/or intermediate wheels/tracks of the autonomous work vehicle 100 or articulate the frame of the vehicle, either individually or in groups. The differential braking system 234 may independently vary the braking force on each lateral side of the autonomous work vehicle 100 to direct the autonomous work vehicle 100. Similarly, the torque vectoring system 236 may differentially apply torque from the engine to the wheels and/or tracks on each lateral side of the autonomous work vehicle 100. While the illustrated steering control system 230 includes the curvature rate control system 232, the differential braking system 234, and the torque vectoring system 236, the steering control system 230 may include one or more of these systems. Further examples may include a steering control system 230 having other and/or additional systems to facilitate turning the autonomous work vehicle 100 such as an articulated steering control system, a differential drive system, and the like.

The speed control system 240, for example, may include an engine output control system 242, a transmission control system 244, and a braking control system 246. The engine output control system 242 may vary the output of the engine to control the speed of the autonomous work vehicle 100. For example, the engine output control system 242 may vary a throttle setting of the engine, a fuel/air mixture of the engine, a timing of the engine, and/or other suitable engine parameters to control engine output. In addition, the transmission control system 244 may adjust gear selection within a transmission to control the speed of the autonomous work vehicle 100. Furthermore, the braking control system 246 may adjust the braking force to control the speed of the autonomous work vehicle 100. While the illustrated speed control system 240 includes the engine output control system 242, the transmission control system 244, and the braking control system 246, the speed control system 240 may include one or two of these systems. The speed control system 240, for example, may also include other systems and/or additional systems that may be used to control the speed of the autonomous work vehicle 100.

The implement control system 250, for example, may control various parameters of the implement towed by and/or integrated within the autonomous work vehicle 100. For example, the implement control system 250 may instruct an implement controller via a communication link, such as a CAN bus, ISOBUS, Ethernet, wireless communications, and/or Broad R Reach type Automotive Ethernet, etc.

The implement control system 250, for example, may instruct an implement controller to adjust a penetration depth of at least one ground engaging tool of an agricultural implement, which may reduce the draft load on the autonomous work vehicle 100.

The implement control system 250, as another example, may instruct the implement controller to transition an agricultural implement between a working position and a transport portion, for example by means of extending or retracting a hydraulic cylinder 122, to adjust a flow rate of product from the agricultural implement, to adjust a position of a header of the agricultural implement (e.g., a harvester, etc.), among other operations, etc. The implement control system 250, as another example, may instruct the implement controller to adjust a shovel height, a shovel angle, a shovel position, etc.

The communication and control system 200, for example, may include a sensor array 160. The sensor array 160, for example, may facilitate determination of condition(s) of the autonomous work vehicle 100 (e.g., tractor 112), the implement 114, and/or the work area. For example, the sensor array 160 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel (i.e., wheel speed) and/or track a ground speed of the autonomous work vehicle 100. The sensors (e.g., of the sensor array 160) may alternatively or additionally monitor operating levels (e.g., temperature, fuel level, engine torque, hydraulic fluid pump speed, or hydraulic fluid flow rate into or out of the hydraulic cylinder 122, etc.) of the autonomous work vehicle 100. The sensors of the sensor array 160 may be external sensor added to an existing autonomous vehicle or integrated with or part of the autonomous work vehicle 100. Furthermore, the sensors may include sensors which can remotely monitor the implement 114 from the tractor 112, such as LiDAR sensors, radar sensors, infrared sensors, cameras etc. Yet further, the sensors may monitor conditions in and around the work area, such as temperature, weather, wind speed, compass, humidity, and other conditions. The sensors of the sensor array 160, for example, may detect physical objects in the work area, such as a parking stall, a material stall, accessories, other vehicles, obstacles, environmental features, or other object(s) that may be in the area surrounding the autonomous work vehicle 100. The sensors of the sensor array 160 may be a part of the original equipment manufacturer system, or may be added onto the tractor 112.

The sensor array 160, for example, may include a velocity sensor which may include one or more of an inertial measurement unit, a compass, a GPS sensor, a wheel encoder, a tachometer, a camera, a radar, etc. The sensor array 160, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle 100 may include an operator interface 222 for controlling the vehicle. The operator interface 222, for example, may be communicatively coupled to the vehicle control unit 220 and configured to present data from the autonomous work vehicle 100 via a display. Display data may include data associated with operation of the autonomous work vehicle 100, data associated with operation of an implement, a position of the autonomous work vehicle 100, a speed of the autonomous work vehicle 100, a desired path, a drivable path plan, a target position, and/or a current position, etc. The operator interface 222 may enable an operator to control certain functions of the autonomous work vehicle 100 such as starting and stopping the autonomous work vehicle 100, inputting a desired path, etc. The operator interface 222, for example, may enable the operator to input parameters that cause the vehicle control unit 220 to adjust the drivable path plan. For example, the operator may provide an input requesting that the desired path be acquired as quickly as possible, that an off-path normal error be minimized, that a speed of the autonomous work vehicle 100 remain within certain limits, and/or that a lateral acceleration experienced by the autonomous work vehicle 100 remain within certain limits, etc. In addition, the operator interface 222 (e.g., via the display, or via an audio system (not shown), etc.) may alert an operator if the desired path cannot be achieved, for example.

The communication and control system 200, for example, may include a base station 270 having a base station controller 274 located remotely from the autonomous work vehicle 100. For example, the control functions of the vehicle control unit 220 may be distributed between the vehicle control unit 220 of the autonomous work vehicle 100 and the base station controller 274. The base station controller 274, for example, may perform a substantial portion of the control functions of the vehicle control unit 220. For example, a first transceiver 226 positioned on the autonomous work vehicle 100 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 276 at the base station 270. The base station controller 274, for example, may calculate drivable path plans and/or output control signals to control the curvature control system 232, the speed control system 240, and/or the implement control system 250 to direct the autonomous work vehicle 100 toward the desired path, for example. The base station controller 274 may include a processor and memory device having similar features and/or capabilities as the processor and the memory device discussed previously. Likewise, the base station 270 may include an operator interface 272 having a display, which may have similar features and/or capabilities as the operator interface 222 and the display discussed previously.

In some embodiments, one or both of the base station 270 and/or the autonomous work vehicle 100 may be in communication with a user device 280. A user device 280 may include a phone, tablet, laptop, or computer. The user device 280 may similarly include an operator interface 282 which may include similar features and capabilities as operator interfaces 222, 272 described above. Additionally, or alternatively, the user device 280 may comprise a controller 284 that may include the same or similar features, components, and/or characteristics as the controller 274 of the base station 270. For example, the user device 280 may calculate drivable path plans, output control signals to control the curvature control system 232, the speed control system 240, and/or the implement control system 250 to direct the autonomous work vehicle 100. The user device 280, for example, can include an application that allows the user (e.g., a remote operator) to communicate commands to the autonomous work vehicle 100 (e.g., via a transceiver 286) and/or receive information about the autonomous work vehicle 100. Alternatively, or additionally, the user device 280, for example, can include an application that allows the operator to observe the autonomous work vehicle 100 move through a map of the work area where the autonomous work vehicle operates.

The user device 280, for example, may include an application that can receive an indication associated with the remote operator or which can receive other user or operator inputs. The user device 280, for example, may include an application that can display any of the information disclosed in this document.

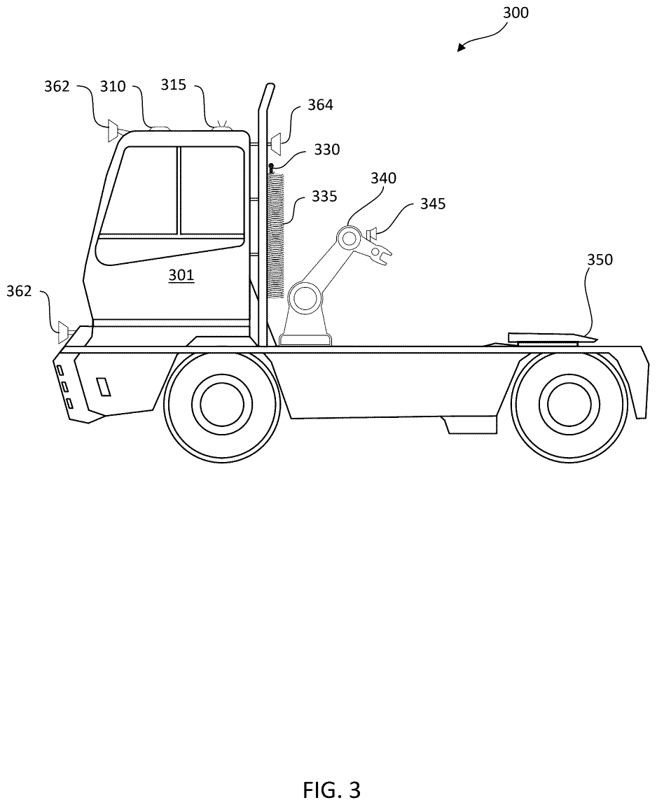

FIG. 3 is a side view of an autonomous yard truck 300 according to some embodiments. The autonomous yard truck 300 includes a cab 301 that may be used to drive the autonomous yard truck 300 manually. The autonomous yard truck 300 may include one or more of the components shown in FIG. 2. The autonomous yard truck 300 may also include a brake system, an engine, a transmission, steering, sensor array, etc. such as, for example, as shown in FIG. 2.

In some embodiments, the autonomous yard truck 300 may include a sensor array that includes sensors 362 (e.g., sensor array 160) disposed at various locations on the autonomous yard truck 300 such as, for example, on the cab 301, bumper, housing, frame, etc. The sensors 362 may include infrared sensors, ultrasonic sensors, magnetic sensors, radar sensors, LiDAR sensors, terahertz sensors, sonar sensors, cameras, etc. The sensor array of the autonomous yard truck 300 may also include one or more backup sensors 364 such as, for example, infrared sensors, ultrasonic sensors, magnetic sensors, radar sensors, LiDAR sensors, terahertz sensors, sonar sensors, cameras, etc.

In some embodiments, the autonomous yard truck 300 may include a spatial locating device (or GPS) antenna 310. In some embodiments, the autonomous yard truck 300 may include a transceiver antenna 315.

In some embodiments, the autonomous yard truck 300 may include one or more hoses 335 that can connect with a trailer such as, for example, two or three hoses. Each hose may have a hose connector 330 that can connect with a trailer hose connector. For example, the one or more hoses 335 of the autonomous yard truck 300 may include a service brake hose, an emergency brake hose, and/or a refrigerant hose.

In some embodiments, the autonomous yard truck 300 may include a robotic arm 340 disposed on the back bed of the autonomous yard truck 300. The robotic arm 340 may include any type of robotic arm. The robotic arm 340, for example, may exert high torque or high pressure sufficient to connect the hose connector 330 with the trailer hose connector. The hose connector 330 and/or the trailer hose connector may comprise a glad-hand connector. In some embodiments, when the autonomous yard truck 300 is not coupled with a trailer, the hose connector 330 may be positioned in a storage rack at some point on the autonomous yard truck 300 such as, for example, on the rear of the cab 301.

In some embodiments, the robotic arm 340 may include one or more arm sensors 345 such as, for example, infrared sensors, ultrasonic sensors, magnetic sensors, radar sensors, LiDAR sensors, terahertz sensors, sonar sensors, cameras, etc. The arm sensor 345, for example, may produce data that can be used to identify the location of a hose connector 330 and/or a trailer hose connector. The arm sensor 345, for example, may produce data that can show that a hose connector 330 and/or a trailer hose connector are sufficiently coupled.

In some embodiments, the autonomous yard truck 300 may include a fifth-wheel coupling 350. The fifth-wheel coupling 350, for example, may be raised or lowered with a fifth-wheel coupling boom. FIG. 3 shows the fifth-wheel coupling 350 in a lowered position. The fifth-wheel coupling 350 may couple with a kingpin of a trailer.

When the fifth-wheel coupling 350 is coupled with a kingpin and the fifth-wheel coupling 350 is in the raised position, the legs of the trailer may lift off the ground (e.g., automatically). This may allow the autonomous yard truck 300 to pull the trailer without individually raising the trailer legs.

In some embodiments, the robotic arm 340 and/or the arm sensor 345 may be coupled with a thermal management system. A thermal management system may, for example, be coupled with a thermal management system associated with the autonomous yard truck 300 such as, for example, coupled with the cab heating/cooling system and/or the engine heating/cooling system. A thermal management system may, for example, be an independent system that heats and/or cools the robotic arm 340 and/or the arm sensor 345. A thermal management system may, for example, keep the temperature of the robotic arm 340 and/or the arm sensor 345 between about 32° F. and about 100° F.

In some embodiments, the autonomous yard truck 300 may include a deployable shade coupled with the back of the cab 301. The deployable shade, for example, may be used to screen the sun and/or other lighting from the arm sensor 345 and/or the one or more backup sensors 364. The deployable shade, for example, may include an umbrella configuration or an awning configuration. The deployable shade, for example, may be coupled with the roof or an upper portion of the cab.

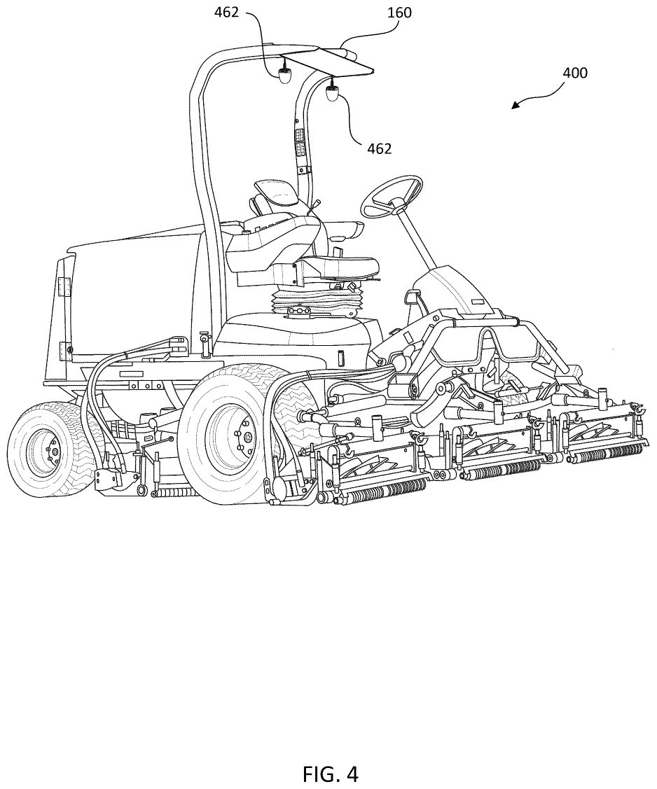

FIG. 4 is a sideview of an example autonomous mower 400, which may include all or some of the components of autonomous work vehicle 100. The autonomous work vehicle in this document may include the autonomous mower 400. Any type of mower or blades may be used, such as a disc mower. The autonomous mower 400, for example, may include a sensor array 160 (or multiple sensor arrays 160), including sensors 462. The sensor array 160 may include, for example, one or more LiDAR, radar, and/or video cameras. The video cameras, for example, may include 360 degree cameras, a front facing camera, and/or a back facing camera.

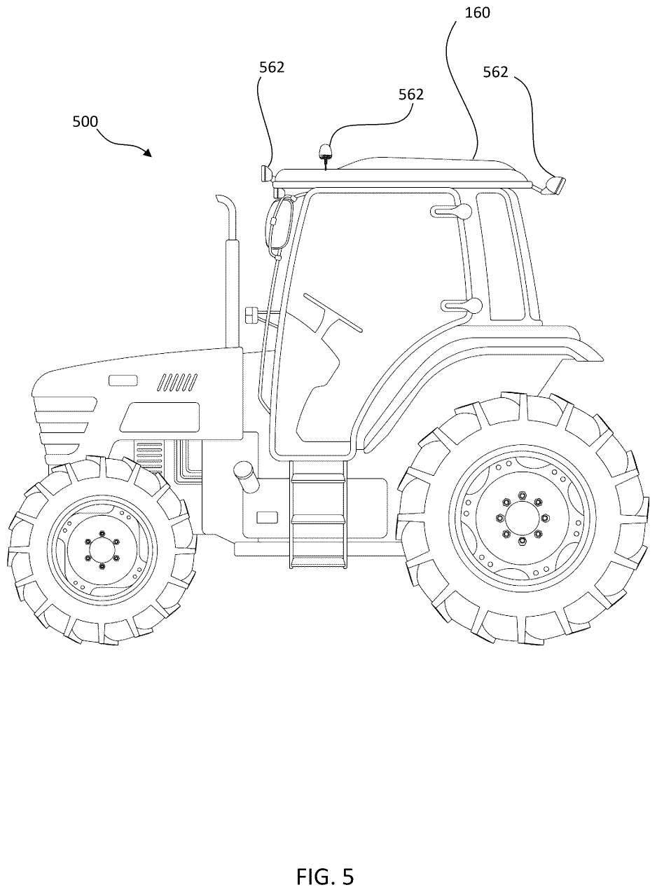

FIG. 5 is a sideview of an example autonomous tractor 500, which may include all or some of the components of autonomous work vehicle 100. The autonomous work vehicle in this document may include the autonomous tractor 500. In this example, the autonomous tractor 500 may include standard tractor equipment and/or components. The autonomous tractor 500 may include or be coupled with any kind of implement such as, for example, a plow, disc plow, reel mower, dumper, lift, bucket, shovel, blade, and/or cutter, etc. The autonomous tractor 500, for example, may include a sensor array 160 (or multiple sensor arrays 160), including sensor(s) 562. The sensor array 160 may include, for example, one or more LiDAR, radar, and/or video cameras. The video cameras, for example, may include 360 degree cameras, a front facing camera, and/or a back facing camera.

The computational system 600, shown in FIG. 6, can be used to perform any of the embodiments of the invention. For example, computational system 600 can be used to execute processes 700 and/or 800. As another example, computational system 600 can be used to perform any calculation, identification, and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard, and/or the like; and one or more output devices 620, which can include without limitation a display device, a printer, and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

The computational system 600 may be configured to operate an autonomous work vehicle platform. The term “autonomous work vehicle”, and related terms (e.g., “autonomous work vehicle platform”), as used herein may include manned vehicles, remote control vehicles, and/or manual vehicles, etc. The autonomous work vehicle platform may comprise a steering mechanism in communication with the processor, where the processor communicates steering commands to the steering mechanism based on the position of the implement. The autonomous work vehicle platform may comprise a braking mechanism in communication with the processor, where the processor communicates braking commands to the braking mechanism based on the position of the implement. The autonomous work vehicle platform or adjustable implement system may comprise an implement control system in communication with the processor, where the processor communicates commands to the implement control system based on the position of the implement. For example, the processor may give commands to the implement control system for controlling a pump to induce a flow of hydraulic fluid (e.g., at a predetermined flow rate) into or out of the hydraulic cylinder for a set time.

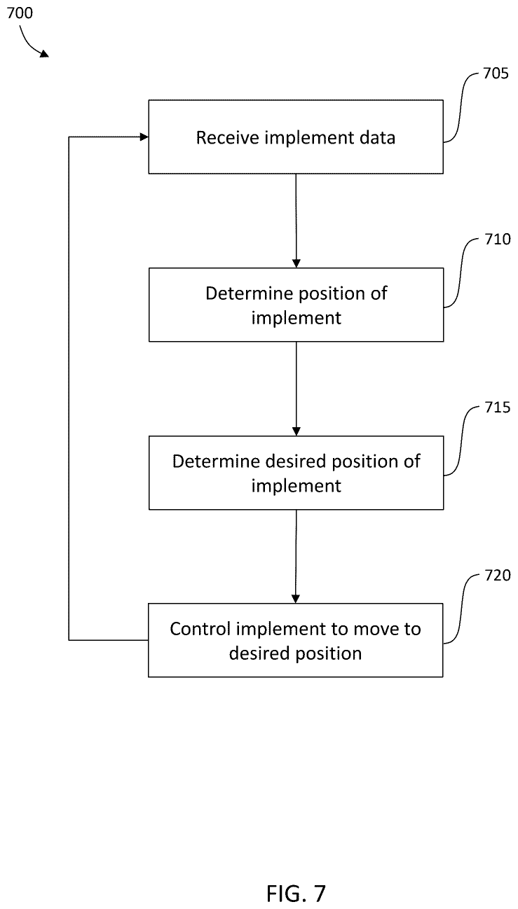

FIG. 7 is a flow chart of a process 700 for controlling an implement 114 to move to a desired position. Process 700 may be executed in part by control system 240 (including the vehicle control unit 220 and/or implement control system 250) and/or base station controller 274.

Process 700 starts at block 705. At block 705, a position control subsystem may receive implement data. Implement data may be received from the sensor array 160 and/or from the vehicle control unit 220. Implement data may include one or more of, for example, flow data relating to the flow rate of hydraulic fluid into or out of the hydraulic cylinder 122, timing data from a clock relating to how long the hydraulic fluid has been flowing at the flow rate, LiDAR data from a sensor mounted on the tractor 112 and monitoring the implement 114, engine torque data of the tractor 112, and tractor wheel speed data. The flow data may be derived from the implement control system 250 which is controlling the flow rate, or it may be received from a flow rate sensor in the hydraulic cylinder 122.

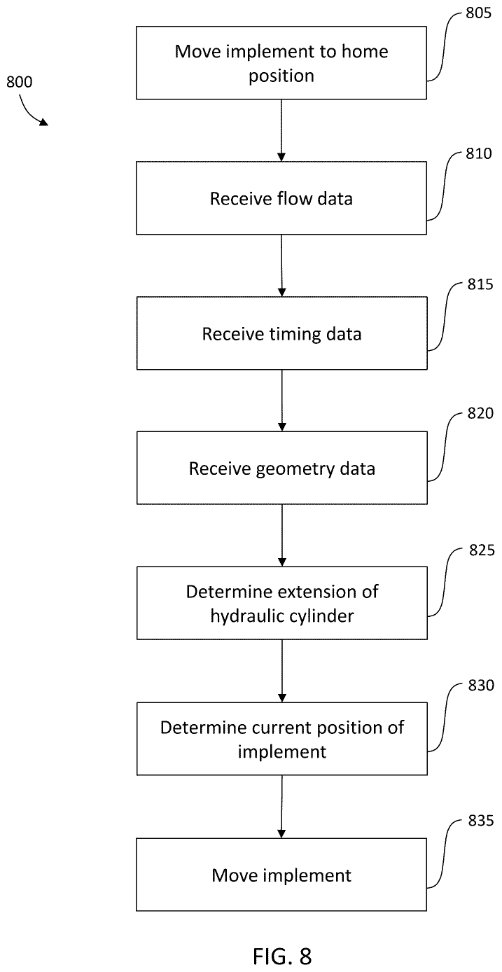

At block 710, the position control subsystem may determine a position of the implement 114 based on the implement data. Determining the position of the implement may relate to determining an absolute position of the implement 114, or a relative position, for example, in relative to optimum operation of the implement 114. Determining the position of the implement may, for example, comprise the process described with reference to FIG. 8 below, where the implement data includes flow data and timing data. In other examples, the implement data may include only timing data, with the flow rate of hydraulic fluid being an assumed constant, or the implement data may include tractor engine torque data, where the tractor engine torque being above a threshold may indicate that a disc harrow is lowered and in contact with a substrate such as soil, whereas the tractor engine torque being at or below the threshold may indicate that the disc harrow is not in contact with the substrate.

Further, in some examples, there may be an optimum engine torque whereby the engine torque being above an optimal level may indicate that a disc harrow is providing too much resistance to movement, such that the position of a disc harrow is too low, thereby determining a relative position of the implement 114 compared to optimal positioning. Furthermore, in examples where the implement data includes wheel speed data, a sudden rise in wheel speed, or wheel speed above a threshold, may indicate a wheel spin or tire slip from which it may be determined that the discs of a disc harrow are in contact with a substrate (absolute position), or that they are too low (relative position). LiDAR data may be used to generate a 3D image of the implement by which its absolute and/or relative position may be determined. Detection of the absolute and/or relative position may beneficially enable the tractor 112 and/or implement 114 to detect and/or compensate for variables of the operating environment, such as slipper ground, mud, soil density, soil type, rocks, or other varying conditions. This may beneficially enable the tractor 112 and/or implement 114 to adjust to prevent deleterious conditions of equipment, such as power hopping, and may enable prevent or reduce operational delays of the autonomous work vehicle 100 by preventing the autonomous work vehicle 100 from slowing, stalling, or becoming stuck. This may also increase the reliability of the autonomous work vehicle 100, despite changing conditions, such as changing weather conditions.

At block 715, the position control subsystem may determine a desired position of the implement 114. For example, where the implement 114 is a disc harrow, a tractor 112 may be following a path on a map, and the map may indicate turns at which the discs should be lifted from the ground, and straight paths where the discs should be lowered into the ground. The location of the autonomous work vehicle 100 on the map may be determined by, for example, GPS or may be derived by timing from a start point along the path and the speed of the tractor 112. Further, in some examples, the desired position of the implement 114 may be a position for optimal functioning of the implement 114. For example, where the engine torque data shows a torque above the threshold or the wheel speed data determines that there is wheel or tire spin (e.g., when wheel rotation with no accompanying change in vehicle position is detected, or based on detection of no or little wheel resistance during driving), the desired position may be a predetermined step change in position higher than the current position.

At block 720, the position control subsystem may control the implement 114 to move to the desired position. This may include, for example, determining a required change in extension of the hydraulic cylinder 122 to reach the desired position, and/or controlling the flow of fluid into or out of the hydraulic cylinder to meet the required change in extension. Controlling the flow of fluid may, for example, include determining a set time required for hydraulic flow into or out of the hydraulic cylinder 122 at a predetermined flow rate to meet the required change in extension of the hydraulic cylinder, and controlling a pump for the set time at the predetermined flow rate. The predetermined flow rate may include any suitable flow rate. Determining the set time may be based on the geometry of the cylinder and a calculated change in volume of hydraulic fluid to be in or needed within the hydraulic cylinder 122. In other examples, determining the set time may include comparing the required change of extension of the hydraulic cylinder 122 with a look-up table including experimental data of changes of extension achieved in different set times for the predetermined flow rate.

FIG. 8 is a flow chart of an example process for determining a current position of an implement. Process 800 may be executed in part by control system 240 (including the vehicle control unit 220 and/or implement control system 250) and/or base station controller 274.

Process 800 may start at block 805. At block 805, a position determination subsystem may control the implement 114 to move to a home position. The home position, for example, may be a maximum or minimum position of the implement 114, or may be a position in which a switch or sensor is triggered to indicate that the implement 114 has reached the home position.

At block 810, the position determination subsystem may receive flow data relating to the flow rate of hydraulic fluid into or out of the hydraulic cylinder 122. The flow data may be derived from the implement control system 250 which is controlling the flow rate (where it is assumed that the implement control system 250 is accurately controlling the flow rate of the hydraulic fluid), or it may be received from a flow rate sensor in the hydraulic cylinder 122.

At block 815, position determination subsystem may receive timing data from a clock in any one of the controllers, relating to how long the hydraulic fluid has been flowing at the flow rate.

At block 820, the position determination subsystem may receive geometry data of the hydraulic cylinder, relating to the geometry of the hydraulic cylinder, such as the diameter of the cylinder, the diameter or size of a rod and/or piston within the cylinder, whether it is a single-acting hydraulic cylinder or a double-acting hydraulic cylinder, etc. For example, the geometry data may be determined from a setting in the system, or may be received from a look-up table.

At block 825, the position determination subsystem may determine a change in extension of the hydraulic cylinder 122. The combination of flow data, timing data may be used to determine the volume of fluid flowing into or out of the hydraulic cylinder 122 from which the change in extension can be calculated using the geometry data.

At block 830, the position determination subsystem may determine a current position of the implement 114. If the starting position of the implement 114 is known (e.g., the home position), the end position of the implement 114 can be calculated based on the change in extension of the hydraulic cylinder 122. For example, if the home position is the hydraulic cylinder 122 at a maximally retracted configuration, then calculating the change in extension of the hydraulic cylinder 122 will enable determination of the current position of the hydraulic cylinder 122.

At block 835, the implement 114 may be controlled to move, for example by manual control by a user, or by automatic control such as in the process 700 of FIG. 7. Once the implement 114 has been moved from the last calculated position, the process 800 can be started again from block 805 or block 810.

Other parameters may be considered for determining the status and/or position of the implement 114. For example, the implement data may comprise the fuel flow sent to or as consumed by the implement 114. The fuel flow to the implement 114 may be stored over time and fuel use deviating from an expected use by the implement 114 may indicate an issue affecting performance of the implement 114. For example, fuel flow significantly above or below a threshold (e.g., a performance average) may indicate that the implement 114 is struggling to perform a task. This may indicate that a component of the implement 114 is malfunctioning, that the implement 114 is plugged with material, or that the implement needs additional maintenance or service. Detection of implement data exceeding performance thresholds may trigger a stop in driving or performance of the autonomous work vehicle 100 and/or of the implement 114, and/or may trigger sending of a notification to an operator or maintenance technicians to service the implement 114.

In another example, the implement data may include one or more dynamics of the vehicle 100 and/or the implement 114, such as a linear velocity, a linear acceleration, a rotational velocity, or a rotational acceleration of one or more components of the vehicle 100 and/or the implement 114. For example, no or reduced rotation of an implement component during performance of the task may indicate a malfunction of the implement 114, and may indicate that the component (e.g., a bearing, fluid lines, actuators) may need to be replaced or that other servicing is required.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied - for example, blocks can be re-ordered, combined, and/or broken into sub-blocks. Certain blocks or processes can be performed in parallel.

The terms “autonomous vehicle” and/or “autonomous work vehicle” may include manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous work vehicle comprising:
a steering control system for autonomously controlling a driving direction of the autonomous work vehicle;
a speed control system for autonomously controlling a speed of the autonomous work vehicle;
an implement connection between the autonomous work vehicle and an implement, wherein the implement is configured to interface with objects of an operating environment;
an implement control system for autonomously controlling a position of the implement;
a sensor array comprising one or more sensors configured to measure one or more parameters of the implement;
one or more processors communicatively coupled with the sensor array, the steering control system, the speed control system, and the implement control system; and
one or more computer-readable media having stored thereon instructions that when executed cause the one or more processors to:
receive implement data from the sensor array, wherein the implement data indicates one or more parameters of the implement;
determine a position of the implement based on the implement data; and
instruct the implement control system to adjust the position of the implement to a desired position.

2. The autonomous work vehicle of claim 1, further comprising:
a hydraulic cylinder attached to the implement;
wherein the implement data comprises timing data from a clock; and
wherein the instructions further cause the one or more processors to:
determine an extension of the hydraulic cylinder based on the timing data; and
determine the position of the implement based on the extension of the hydraulic cylinder.

3. The autonomous work vehicle of claim 2, wherein the implement data further comprises flow data relating to a controlled flow rate of hydraulic fluid into or out of the hydraulic cylinder; and wherein the instructions further cause the one or more processors to determine an extension of the hydraulic cylinder based on the flow data and the timing data.

4. The autonomous work vehicle of claim 1, wherein:
the implement comprises a disc harrow configured to interface with a ground surface of the operating environment, wherein the implement is attached to a hydraulic cylinder for actuating a height of discs of the implement relative to a ground surface of the operating environment;
the one or more sensors of the sensor array includes a flow rate sensor for measuring a flow rate of hydraulic fluid into or out of the hydraulic cylinder;
the implement data comprises timing data from a clock and flow data from the flow rate sensor;
wherein determining a position of the implement based on the implement data comprises determining a height of the discs based on a timing data and the flow data; and
wherein instructing the implement control system to autonomously adjust the position of the implement to a desired position comprises instructing the implement control system to adjust the flow rate of hydraulic fluid into or out of the hydraulic cylinder.

5. The autonomous work vehicle of claim 1, wherein the implement comprises a disc harrow, wherein the sensor array comprises a wheel speed sensor, and wherein the position of the implement is determined based on detection of tire slip.

6. The autonomous work vehicle of claim 1, wherein the implement comprises a disc harrow; and wherein the sensor array comprises a tractor engine torque sensor.

7. The autonomous work vehicle of claim 1, wherein the implement is a digger bucket, a dump truck bed, a shovel, a blade, a thumb, a dump bed, a plow, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a tiller, a rotavator, a ditcher, a dozer blade, a backhoe, an excavator, a spreader, a fertilizer, a seeder, a disc plow, or a plow.

8. The autonomous work vehicle of claim 1, wherein the desired position of the implement is based on the position of the autonomous work vehicle along a selected path.

9. The autonomous work vehicle of claim 1, wherein the desired position of the implement is based on manual input received from an operator.

10. The autonomous work vehicle of claim 1, wherein:
a first sensor of the sensor array generates visual sensor signal data, wherein the visual sensor signal data includes the implement data used to determine the position of the implement and environmental data that represents the operating environment of the autonomous work vehicle; and
wherein the instructions further cause the one or more processors to:
generate a path through an operating environment based on the environmental data; and
instruct the steering control system and the speed control system to drive the autonomous work vehicle along the path.

11. A method for automatically adjusting a position of a vehicle implement, the method comprising:
receiving implement data from one or more sensors of a sensor array, wherein the implement data indicates one or more parameters of an implement, wherein the implement is connected to a work vehicle, and wherein the implement is configured to interface with objects within an operating environment;
determining a position of the implement based on the implement data; and
instructing an implement control system in communication with the implement to adjust the position of the implement to a desired position.

12. The method of claim 11, wherein:
the implement is attached to a hydraulic cylinder; and
the implement data comprises timing data from a clock;
wherein determining an extension of the hydraulic cylinder is based on the timing data; and
wherein determining the position of the implement is based on the extension of the hydraulic cylinder.

13. The method of claim 12, wherein the implement data further comprises flow data relating to a controlled flow rate of hydraulic fluid into or out of a hydraulic cylinder, and wherein determining an extension of the hydraulic cylinder is based on the flow data and timing data.

14. The method of claim 13, wherein instructing the implement control system to automatically adjust the position of the implement to a desired position comprises:
determining a required change in extension of the hydraulic cylinder for the implement to reach the desired position;
determining a set time required for hydraulic flow into or out of the hydraulic cylinder at a predetermined flow rate to meet the required change in extension of the hydraulic cylinder; and
controlling a pump to induce a flow of hydraulic fluid at the predetermined flow rate into or out of the hydraulic cylinder for the set time.

15. The method of claim 11, wherein the implement comprises a disc harrow, wherein the sensor array comprises a wheel speed sensor, and wherein determining the position of the implement is based on detection of tire slip.

16. The method of claim 11, wherein the desired position of the implement is based on the position of an attached vehicle along a selected path.

17. An adjustable implement system comprising:
an implement configured to interface with objects within an operating environment;
a vehicle connection point for attaching the implement to a work vehicle;
a communications connection for receiving implement data from a sensor array, wherein the sensor array comprises one or more sensors configured to measure one or more parameters of the implement;
an implement control system for automatically controlling a position of the implement, the implement control system in communication with the sensor array;
one or more computer-readable media having stored thereon instructions that when executed cause the implement control system to:
receive implement data from the sensor array, wherein the implement data indicate one or more parameters of the implement;
determine a position of the implement based on the implement data; and
instruct the implement control system to automatically adjust the position of the implement to a desired position.

18. The adjustable implement system of claim 17, further comprising:
a hydraulic cylinder attached to the implement;
wherein the sensor array comprises a flow sensor on the hydraulic cylinder;
wherein the implement data comprises:
flow data from the flow sensor relating to a flow rate of hydraulic fluid into or out of the hydraulic cylinder, and
timing data from a clock; and
wherein the implement control system is configured to determine an extension of the hydraulic cylinder based on the flow data and timing data and determine the position of the implement based on the extension of the hydraulic cylinder.

19. The adjustable implement system of claim 17, further comprising a communication link with a vehicle control unit of an autonomous work vehicle and wherein the implement control system receives implement data from the vehicle control unit.

20. The adjustable implement system of claim 17, wherein the implement comprises a disc harrow; wherein the sensor array comprises a wheel speed sensor, and wherein the position of the implement is determined based on detection of tire slip.
